(19) United States
(12) Patent Application Publication
(10) Pub. No.: US 2025/0021812 A1
(43) Pub. Date: Jan. 16, 2025

(54) BASE MODEL SELECTION FOR FINETUNING

(71) Applicant: International Business Machines Corporation, Armonk, NY (US)

(72) Inventors: Leshem Choshen, Jerusalem (IL); Elad Venezian, Binyamina (IL); Shachar Batya Don-Yehiya, Jerusalem (IL); Yoav Avraham Katz, Zichron Yaacov (IL); Noam Slonim, London (GB)

(21) Appl. No.: 18/350,269

(22) Filed: Jul. 11, 2023

(51) Int. Cl. G06N 3/08; G06N 3/0455

(52) U.S. Cl. CPC G06N 3/08; G06N 3/0455

(57) ABSTRACT

Systems and techniques that facilitate base model selection are provided. For example, one or more embodiments described herein can comprise a system, which can comprise a memory that can store computer executable components. The system can also comprise a processor, operably coupled to the memory that can execute the computer executable components stored in memory. The computer executable components can comprise a comparison component that that finetunes a pretrained machine learning model and one or more candidate models selected based on the ranking of the plurality of finetuned machine learning models on one or more target datasets, compares performance of the one or more candidate models to a defined performance metric, and selects a base model from the pretrained machine learning model and the one or more candidate models based on the performance of the one or more candidate models over the one or more target datasets.

### BACKGROUND

The subject disclosure relates to machine learning, and more specifically, to selection of base models for finetuning.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate base model selection.

According to an embodiment, a system can comprise a processor that executes computer executable components stored in memory. The computer executable components can comprise a ranking component that ranks a plurality of finetuned machine learning models based on performance of the plurality of finetuned machine learning models over one or more representative datasets; and a comparison component that finetunes a pretrained machine learning model and one or more candidate models selected based on the ranking of the plurality of finetuned machine learning models on one or more target datasets, compares performance of the one or more candidate models to a defined performance metric, and selects a base model from the pretrained machine learning model and the one or more candidate models based on the performance of the one or more candidate models over the one or more target datasets.

According to another embodiment, a computer-implemented method can comprise ranking, by a system operatively coupled to a processor, a plurality of finetuned machine learning models based on performance of the plurality of finetuned machine learning models over one or more representative datasets; selecting, by the system, one or more candidate models based on the ranking of the plurality of finetuned machine learning models; finetuning, by the system, a pretrained machine learning model and the one or more candidate models on one or more target datasets; comparing, by the system, performance of the one or more candidate models to a defined performance metric; and selecting, by the system, a base model from the pretrained machine learning model and the one or more candidate models based on the performance of the one or more candidate models over the one or more target datasets.

According to another embodiment, a computer program product comprising a computer readable storage medium having program instructions embodied therewith, the program instructions executable by a processor to cause the processor rank, by the processor, a plurality of finetuned machine learning models based on performance of the plurality of finetuned machine learning models over one or more representative datasets; select, by the processor, one or more candidate models from the plurality of finetuned machine learning models based on the ranking plurality of finetuned machine learning models; finetune, by the processor, a pretrained machine learning model and the one or more candidate models on one or more target datasets; compare, by the processor, performance of the one or more candidate models to a defined performance metric; and select, by the processor, a base model from the pretrained machine learning model and the one or more candidate models based on the performance of the one or more finetuned machine learning models over the one or more target datasets.

### DESCRIPTION OF THE DRAWINGS

FIG. 1 illustrates block diagram of an example, non-limiting system that can facilitate base model selection in accordance with one or more embodiments described herein.

FIGS. 2A and 2B illustrate a chart showing the intertraining gains of various finetuned models over various target datasets in accordance with one or more embodiments described herein.

FIG. 3 illustrates a graph showing the correlation between linear probing performance gains and average intertraining gains in accordance with one or more embodiments described herein.

FIG. 4 illustrates a graph showing the effects of source dataset size on intertraining gain in accordance with one or more embodiments described herein.

FIG. 5 illustrates a graph showing the effects of target dataset size on intertraining gain in accordance with one or more embodiments described herein.

FIG. 6 illustrates a flow diagram of an example, non-limiting, computer implemented method that facilitates base model selection in accordance with one or more embodiments described herein.

FIG. 7 illustrates a flow diagram of an example, non-limiting, computer implemented method that facilitates base model selection in accordance with one or more embodiments described herein.

FIG. 8 illustrates a flow diagram of an example, non-limiting, computer implemented method that facilitates base model selection in accordance with one or more embodiments described herein.

FIG. 9 illustrates an example, non-limiting environment for the execution of at least some of the computer code in accordance with one or more embodiments described herein.

FIG. 10 illustrates a block diagram of an example, non-limiting operating environment in which one or more embodiments described herein can be facilitated.

Appendix A is a detailed paper describing various embodiments and is to be considered part of this patent specification.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As referenced herein, an “entity” can comprise a client, a user, a computing device, a software application, an agent, a machine learning (ML) model, an artificial intelligence (AI) model, and/or another entity.

In language-based machine learning, finetuning of pretrained models, such as BERT models, over some target dataset of labeled data is often the standard approach for adjusting such models to perform a downstream task. The resulting finetuned models are typically used for inferring the labels of new examples that are reminiscent of the data used for finetuning. However, some previously finetuned models trained on datasets that differ from the target dataset can represent better base models, namely a better starting point for a new finetuning process on a selected target dataset. This process as referred to herein in is intertraining. However, selection of a finetuned model for use in intertraining can be difficult. For example, not all target datasets are intertraining-sensitive (e.g., have significant potential performance gain from intertraining) and many target datasets are indifferent to base model selection. Additionally, some base models represent a better starting point than others (e.g., most base models consistently degrade performance on target datasets and some provide significant improvement). Therefore, selection of appropriate base models for intertraining can be a difficult task.

To solve this issue, efficient ranking of finetuned machine learning models. independently of the target task, can be performed by training only the base model classification head over a single representative dataset (e.g., via linear probing). As the ranking is done independently of a target task, the same ranking can be utilized multiple times, therefore preventing the need to entirely re-rank base model candidates for each new target task. Once a new target task is received, the ranking can be utilized to select one or more base model candidates. The base model candidates and a pretrained model can then be partially finetuned on the target dataset (e.g., finetuned utilizing a portion of the target dataset, with a limited amount of training cycles, with a limited amount of training time, and/or finetuning only a portion of the models). The performance of the base model candidates and the pretrained model can then be compared to one and other, and the model with the best performance can be selected as the base model for further finetuning over the target dataset.

In view of the problems discussed above, the present disclosure can be implemented to produce a solution to one or more of these problems by finetuning a pretrained machine learning model and the one or more candidate models on one or more target datasets; comparing performance of the one or more candidate models to a defined performance metric; and selecting a base model from the pretrained machine learning model and the one or more candidate models based on the performance of the one or more candidate models over the one or more target datasets By finetuning based on the one or more target dataset sand then comparing the performance to a defined performance metric, a determination can be made as to whether the target dataset is sensitive to intertraining. For example, one or more of the one or mode candidate model exceeds the defined performance metric, then the target dataset is sensitive to intertraining and the base model can be selected from the one or more candidate models. Otherwise, the target dataset may be indifferent to intertraining and the pretrained machine learning model can be selected as the base model. In some embodiments, parameter efficient finetuning, or another form of finetuning utilizing a portion of the machine learning models can be utilized.

In a further embodiment, the present disclosure can be implemented to rank a plurality of finetuned machine learning models based on performance of the plurality of finetuned machine learning models over one or more representative datasets. In an embodiment, the ranking can comprise parameter efficient finetuning the plurality of finetuned machine learning models on one or more representative datasets and comparing the performance of the plurality of finetuned models. By ranking finetuned models based on one or more representative datasets, the finetuned models can be ranked independently of the target dataset. Accordingly, the ranking can be utilized multiple times for different target datasets without having to re-rank the finetuned models for each target dataset, thus decreasing computer computations and operations costs. Furthermore, the ranking can be updated with new finetuned models by finetuning the new finetuned models on the one or more representative datasets. By selecting the one or more candidate models from the plurality of candidate models based on the rankings, finetuned models that have high potential for use in intertraining can be identified, thus preventing brute force identification of base models for each new target dataset.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

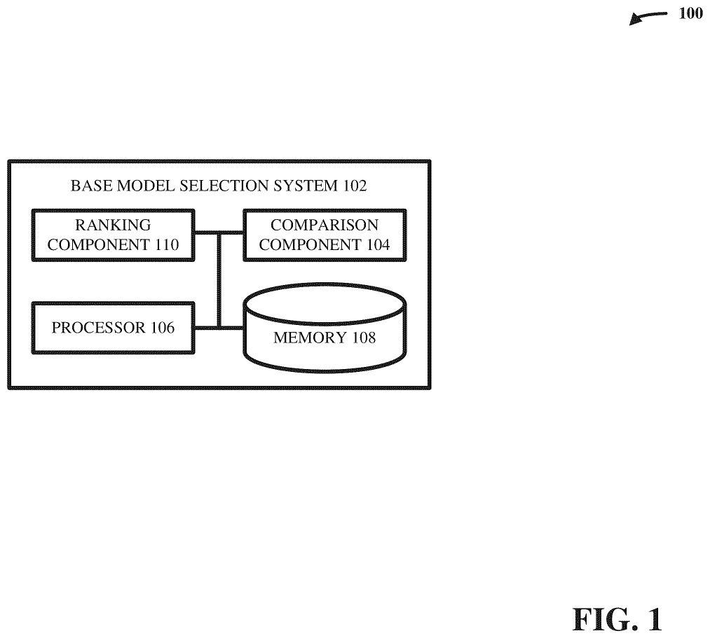

FIG. 1 illustrates block diagram of an example, non-limiting system 100 that can facilitate base model selection in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise ranking component 110, comparison component 104, processor 106 and memory 108.

In various embodiments, base model selection system 102 can comprise a processor 106 (e.g., a computer processing unit, microprocessor) and a computer-readable memory 108 that is operably connected to the processor 106. The memory 108 can store computer-executable instructions which, upon execution by the processor, can cause the processor 106 and/or other components of the base model selection system 102 (e.g., ranking component 110 and/or comparison component 104) to perform one or more acts. In various embodiments, the memory 108 can store computer-executable components (e.g., ranking component 110 and/or comparison component 104), the processor 106 can execute the computer-executable components.

According to some embodiments, the candidate base models, pretrained models and/or finetuned models can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the candidate base models, pretrained models and/or finetuned models can employ principles of probabilistic and decision theoretic inference to determine one or more responses based on information retained in a knowledge source database. In various embodiments, the candidate base models, pretrained models and/or finetuned models can employ a knowledge source database comprising previously generated machine learning outputs. Additionally or alternatively, the candidate base models, pretrained models and/or finetuned models can rely on predictive models constructed using machine learning and/or automated learning procedures. Logic-centric inference can also be employed separately or in conjunction with probabilistic methods. For example, decision tree learning can be utilized to map observations about data retained in a knowledge source database to derive a conclusion as to a response to a question.

As used herein, the term “inference” refers generally to the process of reasoning about or inferring states of the system, a component, a module, the environment, and/or assessments from one or more observations captured through events, reports, data, and/or through other forms of communication. Inference can be employed to identify a specific context or action, or can generate a probability distribution over states, for example. The inference can be probabilistic. For example, computation of a probability distribution over states of interest can be based on a consideration of data and/or events. The inference can also refer to techniques employed for composing higher-level events from one or more events and/or data. Such inference can result in the construction of new events and/or actions from one or more observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects. Furthermore, the inference processes can be based on stochastic or deterministic methods, such as random sampling, Monte Carlo Tree Search, and so on.

The various aspects can employ various artificial intelligence-based schemes for carrying out various aspects thereof. For example, a process for evaluating one or more candidate machine learning models, without interaction from the target entity, which can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to prognose or infer an action that should be employed to make a determination.

A support vector machine (SVM) is an example of a classifier that can be employed. The SVM operates by finding a hypersurface in the space of possible inputs, which hypersurface attempts to split the triggering criteria from the non-triggering events. Intuitively. this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing and recording target entity behavior, by receiving extrinsic information, and so on). For example, SVM's can be configured through a learning phase or a training phase within a classifier constructor and feature selection module. Thus, a classifier(s) can be used to automatically learn and perform a number of functions, including but not limited to, natural language processing. Furthermore, one or more aspects can employ machine learning models that are trained utilizing intertraining.

In one or more embodiments, comparison component 104 can finetune a pretrained machine learning model and one or more candidate models on one or more a target datasets. Some target datasets are intertraining-sensitive, (e.g., have the potential to gain significant performance and/or accuracy from intertraining) while other target sets are indifferent to intertraining (e.g., do have potential gains to performance and/or accuracy from intertraining). As used herein, a pretrained model is a self-supervised machine learning model, such as RoBERTa. A candidate model is a pretrained model that was further trained over some source dataset previously to become a finetuned model. Accordingly, by finetuning a pretrained model and one or more candidate models over a target dataset, performance of the one or more candidate models can be compared to the performance of the pretrained model to determine an amount of gain in performance for the one or more candidate models. In some embodiments, the finetuning of the pretrained model and the candidate models can be controlled by one of more constraints. For example, the finetuning can utilize only a portion of the target dataset, can be limited by a number of training cycles or a training time limit. In some embodiments, parameter efficient finetuning can be utilized. In parameter efficient finetuning, only a portion or select number of layers of a machine learning model are finetuned, thereby decreasing the amount of time and/or computational resources utilized to finetune a model. For example, linear probing can be utilized, wherein only the classification head is finetuned. In an embodiment, the accuracy score obtained by a model can be denote as S^{t}ₘ, wherein t is the target set, and m is the model. The intertraining gain of candidate model m, is then defined as gain(m, t) =S^{t}ₘ−S^{t}_{PT}, where PT is the pretrained model. If the gain is negative, then the pretrained model has outperformed the candidate model, and the target dataset is not sensitive to intertraining, while if the gain is positive, the candidate model has outperformed the pretrained model and the target dataset may be sensitive to intertraining.

The amount of positive gain can indicate the degree to which a target dataset is sensitive to intertraining. For example, a dataset with a gain of 3 is likely more sensitive to intertraining than a dataset with a gain of 1. Accordingly, if the gain is positive, the candidate model can be selected as the base model for further finetuning, and if the gain is negative, the pretrained model can be selected as the base model for further finetuning. In some embodiments, the gain of the candidate model can be compared to a defined performance metric. For example, in some instances, a relatively small positive gain may not justify utilizing the candidate model as the base model. Accordingly, an entity or user can set a defined performance metric, wherein if the gain of the candidate model meets or exceeds the defined performance metric, the candidate model is selected as the base model and if the gain of the candidate model does not meet the defined performance metric, the pretrained model can be selected as the base model. In some embodiments, the performance gains of multiple candidate models can be determined and the candidate model with the highest performance gain can be compared to the defined performance metric in order to select the base model. Once the base model has been selected, the base model can be further finetuned. For example, the base model can be finetuned for an additional amount of time, an additional number of training cycles, using a larger dataset, and/or finetuning additional layers or portions of the base model that were not previously finetuned.

In one or more embodiments, ranking component 110 can rank, by the system, a plurality of finetuned machine learning models and select, by the system, the one or more candidate models from the plurality of finetuned machine learning models based on the ranking. Some finetuned models provide relatively high gains from intertraining over multiple target datasets when compared to other finetuned models. Accordingly, a finetuned model that exhibits strong intertraining performance gains on one dataset, will likely exhibit strong intertraining performance gains on other target datasets. This allows for a single ranking system to be utilized to select finetuned models for use in intertraining for multiple target datasets.

In one or more embodiments, the ranking process can comprise finetuning the plurality of finetuned machine learning models on one or more representative datasets and comparing the performance gains of the plurality of finetune machine learning models. The representative dataset can comprise different classification labels from an intended target dataset. Furthermore, the representative dataset can be a dataset that is known to be sensitive to intertraining, in order to better identify base model candidates. The plurality of finetuned machine learning models can comprise one or more machine learning models that were previously finetuned on datasets with different classification labels from either the one or more target datasets or the one or more representative datasets. Additionally and/or alternatively, the plurality of finetuned models can comprise one or more machine learning models that were previously finetuned utilizing different finetuning methods. For example, a first finetuned model can be previously finetuned with a first finetuning method and a second finetuned model can be previously finetuned using a second finetuning method. In an example, given a finetuned model m, a linear probe of m can be trained (e.g., train only the classification head of m) over a representative dataset and the performance gain can be denoted as LP (m, MNLI), wherein MNLI is the representative dataset. In other examples, various other forms of parameter efficient finetuning can be utilized in place of and/or in addition to linear probing. This gain is a good proxy for the quality of model m for various target datasets. Accordingly, the respective gains of a plurality of finetuned models can be calculate as described above and then ranked according to performance gains. This ranking can illustrate the best models for intertraining. Based on the rankings, ranking component 110 can select one or more candidate models for use by comparison component 104. For example, the ranking component 110 can select the highest ranked finetuned model. In other examples, the ranking component 110 can select multiple high ranked finetuned models for use by comparison component 104. As the rankings are independent of various target datasets, a single ranking can be computed and utilized across multiple target datasets, preventing the need for rankings based on individual target datasets. Furthermore, the rankings can be updated with new finetuned models without the need for re-determining the performance gains of all the finetuned models. For example, given a new finetuned model, the performance gain for the new finetuned model can be calculated as described above and the new finetuned model can be inserted into the rankings based on the performance gain.

In some embodiments, a select number of finetuned models can be ranked one or more additional times. For example, after ranking the plurality of finetuned models, the top N number finetuned models can be selected and ranked an additional time. In another example, the ranking component 110 can select the highest N ranked finetuned models as candidate models, wherein N is a number specified by an entity or user. This additional ranking can be based on a second representative dataset, an additional amount of finetuning cycles, an additional amount of finetuning time, and or utilizing one or more additional finetuning methods. In some embodiments, the ranking component 110 can select the one or more candidate models from the additional rankings. In some embodiments, ranking component 110 can produce multiple rankings of the plurality of finetuned models based on different types of classification tasks. For example, the ranking component 110 can generate a first ranking of finetuned models for natural language processing of the English language, and a second ranking of finetuned models for natural language processing of the German language.

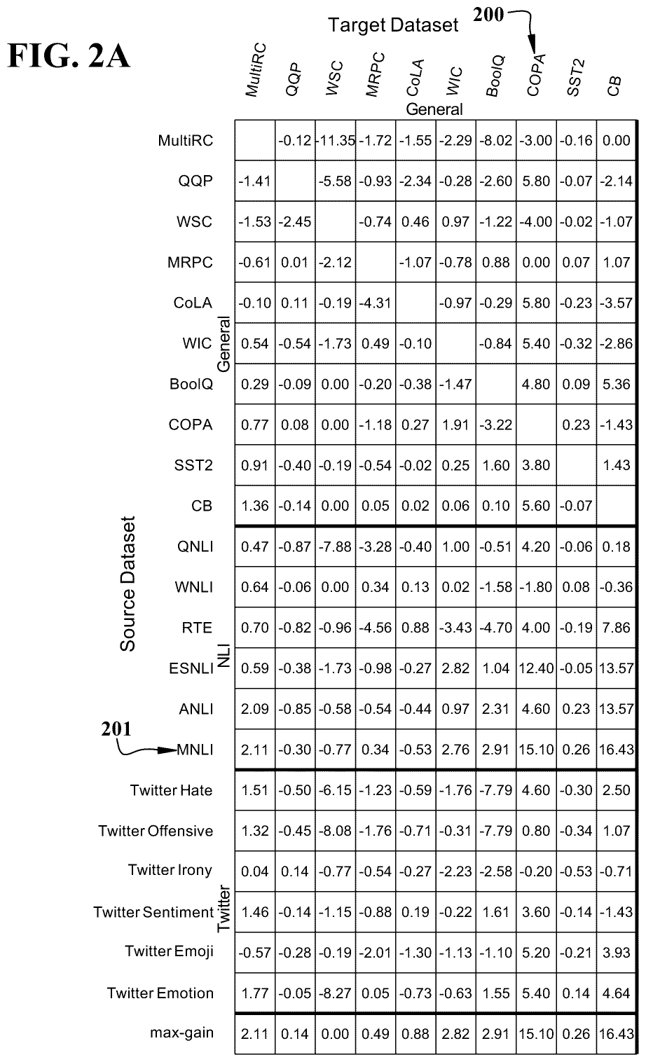

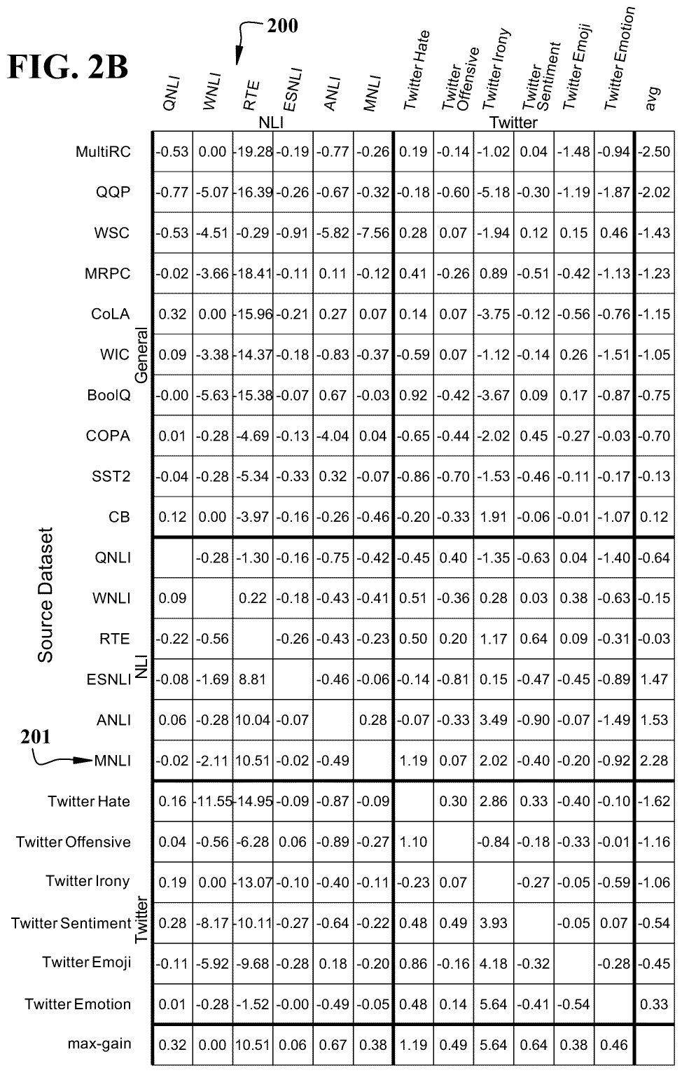

FIGS. 2A and 2B illustrate a chart 200 showing the intertraining gains of various finetuned models over various target datasets in accordance with one or more embodiments described herein.

The rows of chart 200 show the source dataset used to train the finetuned model, while the rows show target datasets for intertraining. The values correspond to the performance gain from using intertraining in comparison to a pretrained model. As shown, some columns and some rows depict consistently high intertraining gains (e.g., positive numbers), while others the impact is minor or negative (e.g., negative numbers). For example, a model finetuned on the MNLI dataset (e.g., row 201) exhibits strong intertraining gains across a variety of unrelated datasets. Similarly, various models exhibit high intertraining gains on the COPA target dataset (e.g., column 210), regardless of which source dataset was used to previously finetune the model. Taken together, these observations illustrate that there is little to no dependence between the source dataset used to generate the finetuned model and the intertraining performance of the finetuned model, which is in contrast to common assumptions. Similarly, these observations illustrate that some finetuned models exhibit strong intertraining gains across a variety of target datasets. Accordingly, the ranking component 110 as described above in reference to FIG. 1, can be used to identify finetuned models that exhibit generally high intertraining gains, and the comparison component 104 can be used to determine whether a target dataset is sensitive to intertraining.

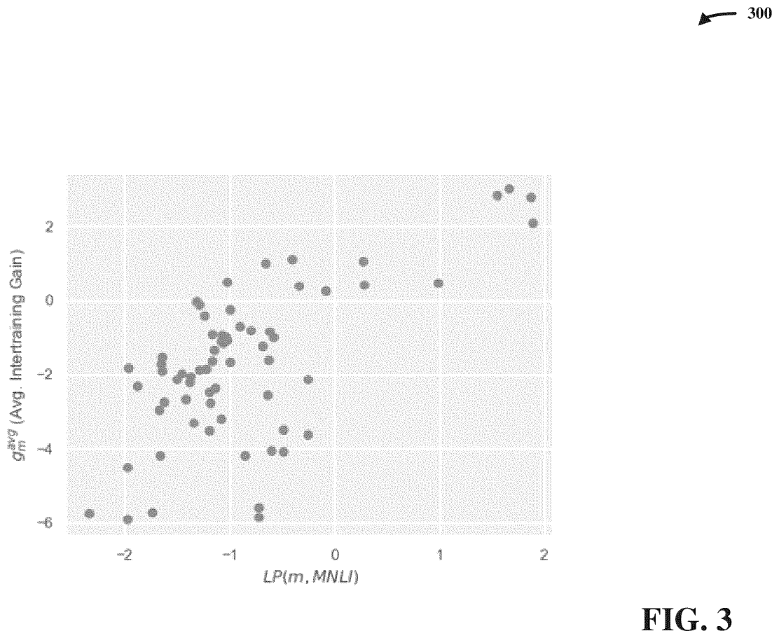

FIG. 3 illustrates a graph 300 showing the correlation between linear probing performance gains and average intertraining gains in accordance with one or more embodiments described herein.

The x-axis of graph 300 illustrates the gain of linear probes (e.g., only a trained classification head) finetuned over the MNLI dataset, denoted as LP (m, MNLI), and the y-axis shows the average gain of the same models for various target datasets, denoted as gₘ^{avg}. Accordingly, the x-axis shows the intertraining gains of a model over a single target dataset and the y-axis shows the average gains of the same model across a variety of target datasets. As shown by the points of graph 300, there is a strong correlation between the x and y-axis (e.g., models with high intertraining gains over a single target dataset exhibit high intertraining gains over many target datasets). Accordingly, this observation is utilized by ranking component 110 of FIG. 1, which ranks candidate models based on intertraining gains of a single dataset, and utilizes the rankings to select candidate models for finetuning on other datasets.

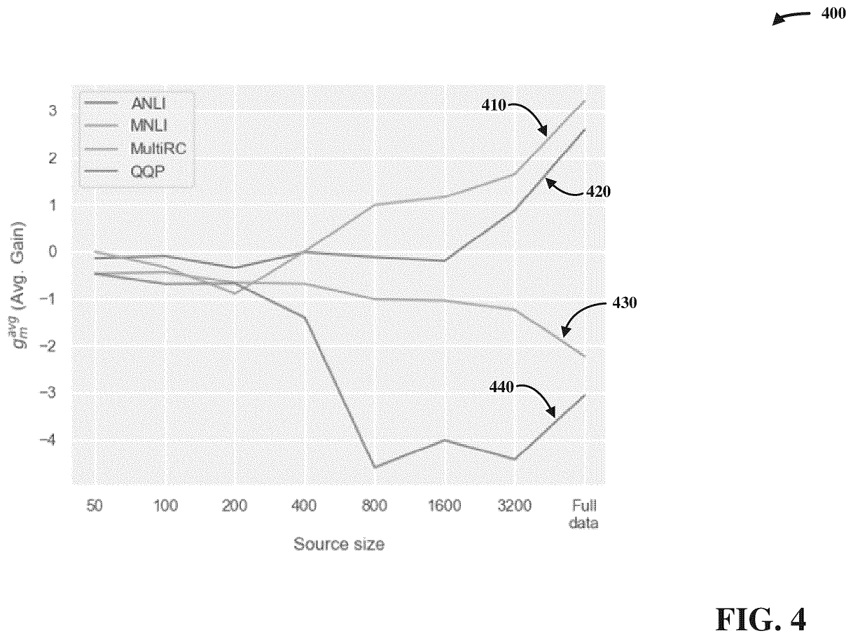

FIG. 4 illustrates a graph 400 showing the effects of source dataset size on intertraining gain in accordance with one or more embodiments described herein.

The x-axis of graph 400 illustrates the size of a source dataset (e.g., the number of samples used) and the y-axis shows the average gain of the same models for various target datasets, denoted as gₘ^{avg}. Line 410 shows the performance of a model trained on the MNLI dataset, line 420 shows the performance of a model trained on the ANLI dataset, line 430 shows the performance of a model trained on the MultiRC dataset, and line 440 shows the performance of a model trained on the QQP dataset. As shown in chart 200 of FIG. 2, models trained on the MNLI and ANLI datasets generally exhibit strong intertraining gains and models trained on the MultiRC and QOP datasets generally exhibit little to no intertraining gains. Accordingly, while graph 400 does show that source dataset size does play some role in intertraining gains, whether the gains are increased or decreased by larger datasets is based on whether the source dataset as whole produces models with good performance or poor performance.

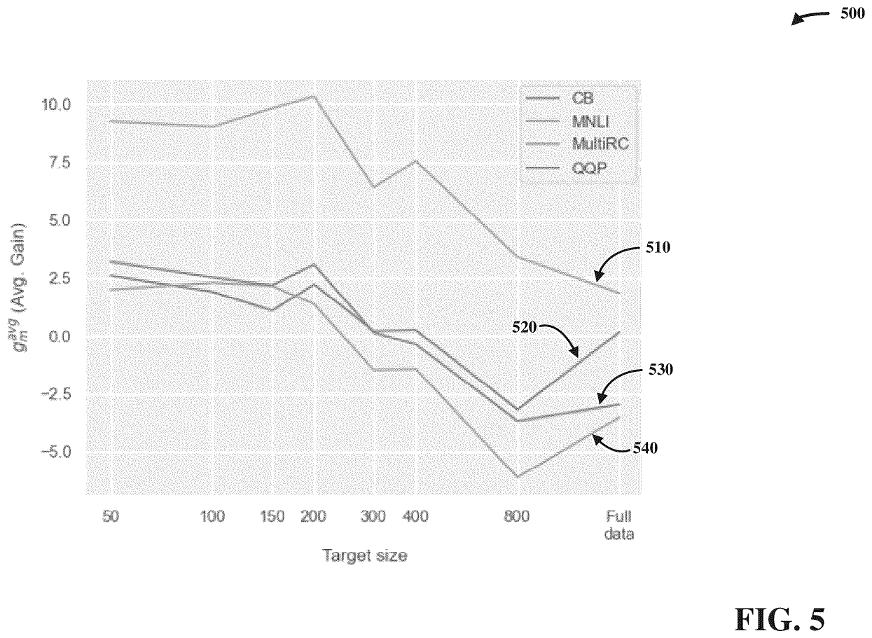

FIG. 5 illustrates a graph 500 showing the effects of target dataset size on intertraining gain in accordance with one or more embodiments described herein.

The x-axis of graph 500 illustrates the size of a source dataset (e.g., the number of samples used) and the y-axis shows the average gain of the same models for various target datasets, denoted as gₘ^{avg}. Line 510 shows the performance of a model trained on the MNLI dataset, line 520 shows the performance of a model trained on the CB dataset, line 530 shows the performance of a model trained on the QQP dataset, and line 540 shows the performance of a model trained on the MultiRC dataset. As shown, the gain decreases as the target dataset training size increases, implying larger potential for intertraining gain when the target dataset is limited.

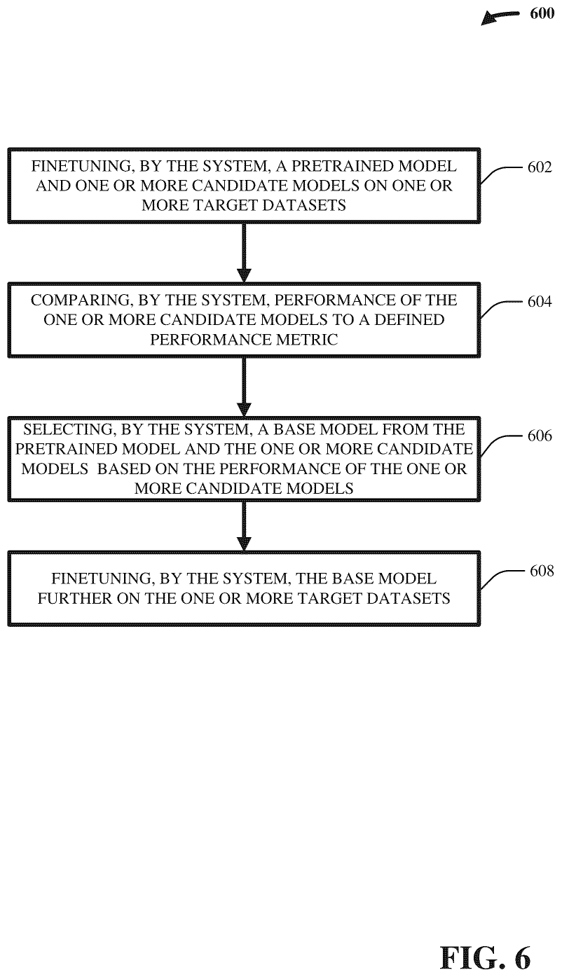

FIG. 6 illustrates a flow diagram of an example, non-limiting, computer implemented method 600 that facilitates base model selection in accordance with one or more embodiments described herein. Repetitive description of like elements employed in other embodiments described herein is omitted for sake of brevity.

At 602, method 600 can comprise finetuning, by system (e.g., base model selection system 102 and/or comparison component 104) operatively coupled to a processor (e.g., processor 106), a pretrained model and one or more candidate models on one or more target datasets. In an embodiment, the finetuning can be limited to a portion of the one or more target datasets, a limited number of training cycles, a limited amount of training time, and/or can utilize a parameter efficient finetuning model.

At 604, method 600 can comprise comparing, by the system (e.g., base model selection system 102 and/or comparison component 104), performance of the one or more candidate models to a defined performance metric. For example, performance gain of the one or more candidate models can be determined by comparing the accuracy of the one or more candidate models and the pretrained model.

At 606, method 600 can comprise selecting, by the system (e.g., base model selection system 102 and/or comparison component 104), a base model from the pretrained model and the one or more candidate models based on the performance of the one or more candidate models. For example, the base model can be selected based on the performance gains of the one or more candidate models over the one or more target datasets.

At 608, method 600 can comprise finetuning, by the system (e.g., base model selection system 102 and/or comparison component 104), the base model further on the one or more target datasets. For example, the base model can be further finetuned utilizing additional finetuning time, additional finetuning cycles, and/or one or more additional finetuning methods.

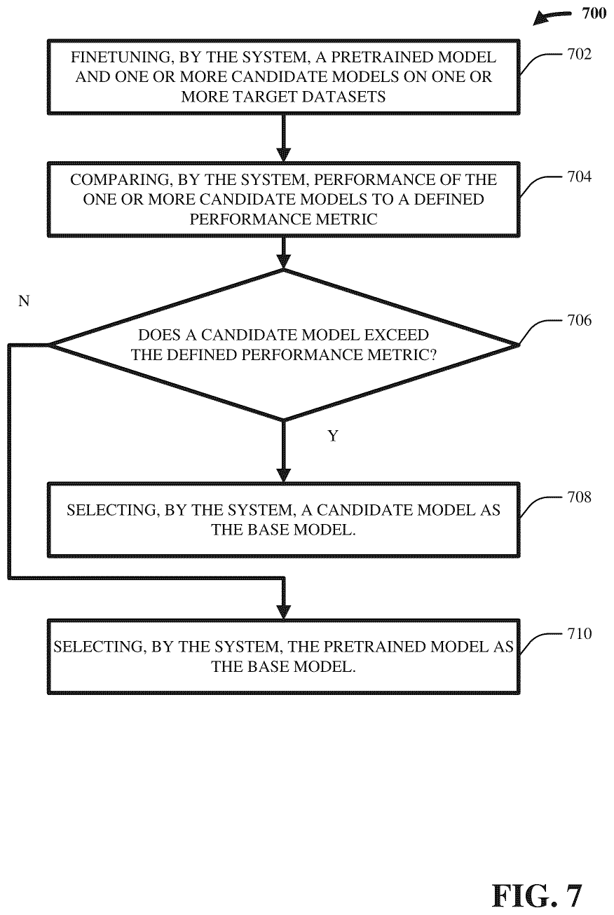

FIG. 7 illustrates a flow diagram of an example, non-limiting, computer implemented method 700 that facilitates base model selection in accordance with one or more embodiments described herein. Repetitive description of like elements employed in other embodiments described herein is omitted for sake of brevity.

At 702, method 700 can comprise finetuning, by system (e.g., base model selection system 102 and/or comparison component 104) operatively coupled to a processor (e.g., processor 106), a pretrained model and one or more candidate models on one or more target datasets. In an embodiment, the finetuning can be limited to a portion of the one or more target datasets, a limited number of training cycles, a limited amount of training time, and/or can utilize a parameter efficient finetuning model.

At 704, method 700 can comprise comparing, by the system (e.g., base model selection system 102 and/or comparison component 104), performance of the one or more candidate models to a defined performance metric. For example, performance gain of the one or more candidate models can be determined by comparing the accuracy of the one or more candidate models and the pretrained model.

At 706, method 700 can comprise a determination, by the system (e.g., base model selection system 102 and/or comparison component 104), of whether the gain of the one or more candidate models meets or exceeds the defined performance metric. If the gain of one or more of the candidate models meets or exceeds the defined performance metric, then the comparison component 104 can select the candidate model with the highest gain as the base model. If the performance of the one or more candidate models does not meet or exceed the defined performance metric, the pretrained model can be selected as the base model.

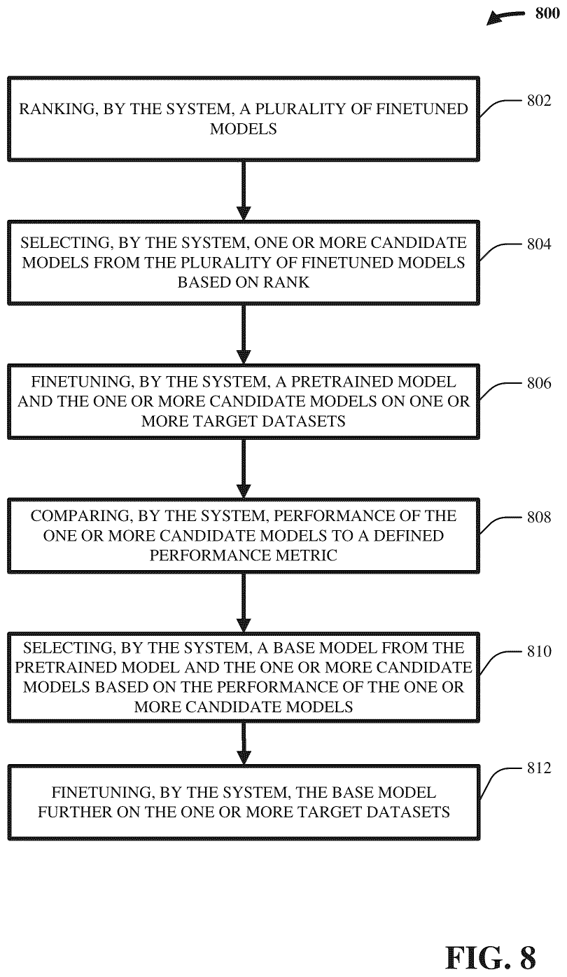

FIG. 8 illustrates flow diagram of an example, non-limiting, computer implemented method 800 that facilitates base model selection in accordance with one or more embodiments described herein. Repetitive description of like elements employed in other embodiments described herein is omitted for sake of brevity.

At 802, method 800 can comprise ranking, by a system (e.g., base model selection system 102 and/or ranking component 110) operatively coupled to a processor (e.g., processor 106), a plurality of finetuned machine learning models based on performance of the plurality of finetuned machine learning models over one or more representative datasets. For example, ranking component 110 can finetune the classification heads of the plurality of finetuned machine learning models using one or more representative datasets or another form of parameter efficient finetuning. The ranking component can then rank the plurality of finetuned models based on the accuracy of their predictions to generate a performance ranking of the plurality of finetuned models.

At 804, method 800 can comprise selecting, by the system (e.g., base model selection system 102 and/or ranking component 110), one or more candidate models from the plurality of finetuned models based on the rankings. For example, the ranking component 110 can select the highest ranked finetuned model from the rankings as the candidate model. In an alternative example, the ranking component 110 can select the highest N ranked finetuned models as candidate models, wherein N is a number specified by an entity or user.

At 806, method 800 can comprise finetuning, by the system (e.g., base model selection system 102 and/or comparison component 104), a pretrained model and one or more candidate models on one or more target datasets. In an embodiment, the finetuning can be limited to a portion of the one or more target datasets, a limited number of training cycles, a limited amount of training time, and/or can utilize a parameter efficient finetuning model.

At 808, method 800 can comprise comparing, by the system (e.g., base model selection system 102 and/or comparison component 104), performance of the one or more candidate models to a defined performance metric. For example, performance gain of the one or more candidate models can be determined by comparing the accuracy of the one or more candidate models and the pretrained model.

At 810, method 800 can comprise selecting, by the system (e.g., base model selection system 102 and/or comparison component 104), a base model from the pretrained model and the one or more candidate models based on the performance of the one or more candidate models. For example, the base model can be selected based on the performance gains of the one or more candidate models over the one or more target datasets.

At 812, method 800 can comprise finetuning, by the system (e.g., base model selection system 102 and/or comparison component 104), the base model further on the one or more target datasets. For example, the base model can be further finetuned utilizing additional finetuning time, additional finetuning cycles, and/or one or more additional finetuning methods.

Base model selection system 102 can provide technical improvements to a processing unit associated with machine learning. For example, by reutilizing a ranking system of intertraining models for multiple base model selection processes, models do not need to be re-ranked each time, thereby reducing the workload of a processing unit (e.g., processor 106) that is employed to execute routines (e.g., instructions and/or processing threads) involved in base model selection. In this example, by reducing the workload of such a processing unit (e.g., processor 106), base model selection system 102 can thereby facilitate improved performance, improved efficiency, and/or reduced computational cost associated with such a processing unit.

A practical application of base model selection system 102 is that it allows for base model selection utilizing a reduced amount of computing and/or network resources, in comparison to other methods. For example, rather than testing all available models to determine the best intertraining performance for each target dataset, the use of the precalculated rankings decreased the number of models that are tested during a base model selection system. Furthermore, by determining whether the target dataset is sensitive to intertraining, base model selection system 102 can prevent selection of finetuned models that may produce worse outputs than pretrained models.

It is to be appreciated that base model selection system 102 can utilize various combination of electrical components, mechanical components, and circuity that cannot be replicated in the mind of a human or performed by a human as the various operations that can be executed by base model selection system 102 and/or components thereof as described herein are operations that are greater than the capability of a human mind. For instance, the amount of data processed, the speed of processing such data, or the types of data processed by base model selection system 102 over a certain period of time can be greater, faster, or different than the amount, speed, or data type that can be processed by a human mind over the same period of time. According to several embodiments, base model selection system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that base model selection system 102 can include information that is impossible to obtain manually by an entity, such as a human user. For example, the type, amount, and/or variety of information included in base model selection system 102 can be more complex than information obtained manually by an entity, such as a human user.

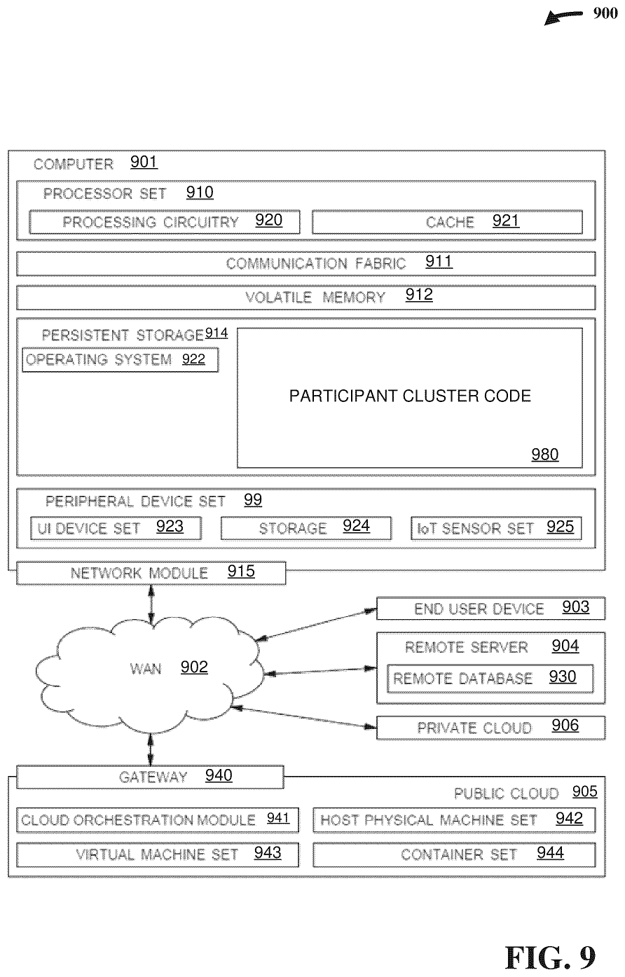

FIG. 9 and the following discussion are intended to provide a brief, general description of a suitable computing environment 900 in which one or more embodiments described herein at FIGS. 1-8 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as translation of an original source code based on a configuration of a target system by the base model selection code 980. In addition to block 980, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 980, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method can be distributed among multiple computers and/or between multiple locations. On the other hand, in this presentation of computing environment 900, detailed discussion is focused on a single computer, specifically computer 901, to keep the presentation as simple as possible. Computer 901 can be located in a cloud, even though it is not shown in a cloud in FIG. 9. On the other hand, computer 901 is not required to be in a cloud except to any extent as can be affirmatively indicated.

PROCESSOR SET 910 includes one, or more, computer processors of any type now known or to be developed in the future. Processing circuitry 920 can be distributed over multiple packages, for example, multiple, coordinated integrated circuit chips. Processing circuitry 920 can implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set can be located “off chip.” In some computing environments, processor set 910 can be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods can be stored in block 980 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory can be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 can be a read only memory (ROM), but typically at least a portion of the persistent storage allows writing of data, deletion of data and re-writing of data. Some familiar forms of persistent storage include magnetic disks and solid-state storage devices. Operating system 922 can take several forms, such as various known proprietary operating systems or open-source Portable Operating System Interface type operating systems that employ a kernel. The code included in block 980 typically includes at least some of the computer code involved in performing the inventive methods.

PERIPHERAL DEVICE SET 914 includes the set of peripheral devices of computer 901. Data communication connections between the peripheral devices and the other components of computer 901 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 can include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 can be persistent and/or volatile. In some embodiments, storage 924 can take the form of a quantum computing storage device for storing data in the form of qubits. In embodiments where computer 901 is required to have a large amount of storage (for example, where computer 901 locally stores and manages a large database) then this storage can be provided by peripheral storage devices designed for storing large amounts of data, such as a storage area network (SAN) that is shared by multiple, geographically distributed computers. IoT sensor set 925 is made up of sensors that can be used in Internet of Things applications. For example, one sensor can be a thermometer and another sensor can be a motion detector.

NETWORK MODULE 915 is the collection of computer software, hardware, and firmware that allows computer 901 to communicate with other computers through WAN 902. Network module 915 can include hardware, such as modems or Wi-Fi signal transceivers. software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and can take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 can be a client device, such as thin client, heavy client, mainframe computer and/or desktop computer.

REMOTE SERVER 904 is any computer system that serves at least some data and/or functionality to computer 901. Remote server 904 can be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data can be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs can be stored as images and can be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware and firmware allowing public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

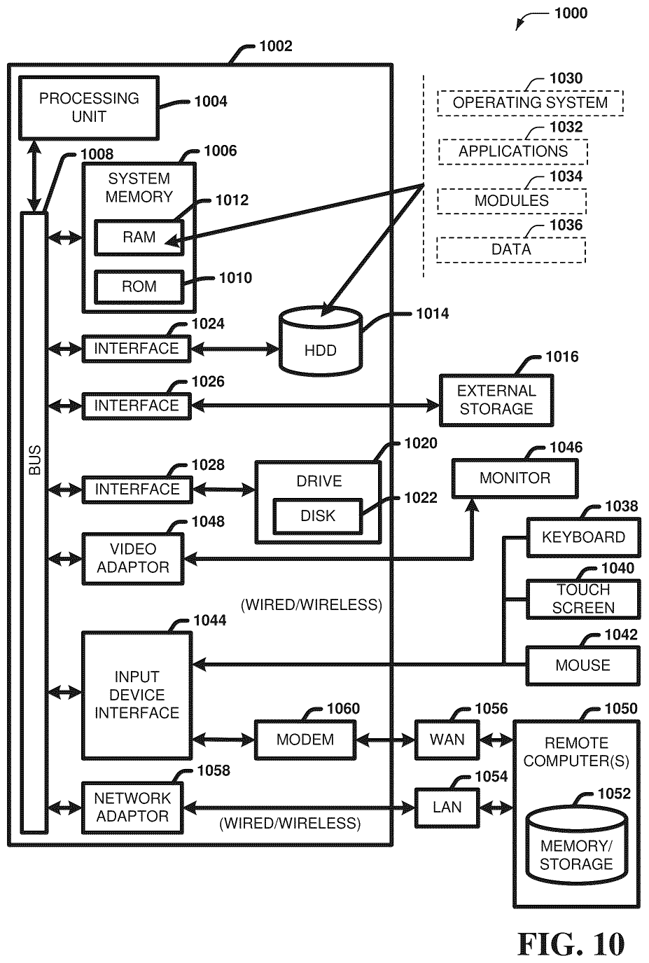

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity.

With reference to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1010, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1094 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be cither volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components;
a processor that executes the computer executable components stored in the memory, wherein the computer executable components comprise:
a ranking component that ranks a plurality of finetuned machine learning models based on performance of the plurality of finetuned machine learning models over one or more representative datasets; and
a comparison component that finetunes a pretrained machine learning model and one or more candidate models selected based on the ranking of the plurality of finetuned machine learning models on one or more target datasets, compares performance of the one or more candidate models to a defined performance metric, and selects a base model from the pretrained machine learning model and the one or more candidate models based on the performance of the one or more candidate models over the one or more target datasets.

2. The system of claim 1, wherein the ranking component further:
parameter efficiently finetunes the plurality of finetuned machine learning models on the one or more representative datasets; and
compares the performance of the plurality finetuned machine learning models.

3. The system of claim 2, wherein the parameter efficiently finetuning comprises a linear probe finetuning.

4. The system of claim 2, wherein the ranking component further adds a new finetuned machine learning model to the plurality of finetuned machine learning models and updates the ranking of the plurality of finetuned machine learning models with the new finetuned machine learning model.

5. The system of claim 2, wherein the one or more representative datasets comprises different classification labels from the one or more target datasets.

6. The system of claim 1, wherein one or more finetuned machine learning models of the plurality of finetuned machine learning models are previously finetuned on a plurality of datasets.

7. The system of claim 1, wherein one or more finetuned machine learning models of the plurality of finetuned machine learning models are previously finetuned on a plurality of finetuning methods.

8. A computer-implemented method comprising:
ranking, by a system operatively coupled to a processor, a plurality of finetuned machine learning models based on performance of the plurality of finetuned machine learning models over one or more representative datasets;
selecting, by the system, one or more candidate models based on the ranking of the plurality of finetuned machine learning models;
finetuning, by the system, a pretrained machine learning model and the one or more candidate models on one or more target datasets;
comparing, by the system, performance of the one or more candidate models to a defined performance metric; and
selecting, by the system, a base model from the pretrained machine learning model and the one or more candidate models based on the performance of the one or more candidate models over the one or more target datasets.

9. The computer-implemented method of claim 8, further comprising:
finetuning, by the system, the base model further on the one or more target datasets.

10. The computer-implemented method of claim 8, wherein the ranking comprises:
parameter efficient finetuning, by the system, the plurality of finetuned machine learning models on a representative dataset; and
comparing, by the system, the performance of the plurality of finetuned machine learning models.

11. The computer-implemented method of claim 10, wherein the parameter efficient finetuning comprises a linear probe finetuning.

12. The computer-implemented method of claim 8, further comprising:
adding, by the system, a new finetuned machine learning model to the plurality of finetuned machine learning models; and
updating, by the system, the ranking of the plurality of finetuned machine learning models.

13. The computer-implemented method of claim 10, wherein the representative dataset comprises different classification labels from the one or more target datasets.

14. The computer-implemented method of claim 8, wherein one or more finetuned machine learning models of the plurality of finetuned machine learning models are previously finetuned on a plurality of datasets.

15. A computer program product, comprising a computer readable storage medium having program instructions embodied therewith, the program instructions executable by a processor to cause the processor to:
rank, by the processor, a plurality of finetuned machine learning models based on performance of the plurality of finetuned machine learning models over one or more representative datasets;
select, by the processor, one or more candidate models from the plurality of finetuned machine learning models based on the ranking of the plurality of finetuned machine learning models;
finetune, by the processor, a pretrained machine learning model and the one or more candidate models on one or more target datasets;
compare, by the processor, performance of the one or more candidate models to a defined performance metric; and
select, by the processor, a base model from the pretrained machine learning model and the one or more candidate models based on the performance of the one or more candidate models over the one or more target datasets.

16. The computer program product of claim 15, wherein the ranking comprises:
parameter efficient finetuning, by the processor, the plurality of finetune machine learning models on a representative dataset; and
comparing, by the processor, the performance of the plurality of finetuned machine learning models.

17. The computer program product of claim 16, wherein the parameter efficient finetuning comprises a linear probe finetuning.

18. The computer program product of claim 15, wherein the program instructions are further executable by the processor to cause the processor to:
add, by the processor, a new finetuned machine learning model to the plurality of candidate models; and
update, by the processor, the ranking of the plurality of finetuned machine learning models.

19. The computer program product of claim 15, wherein one or more finetuned machine learning models of the plurality of finetuned machine learning models are previously finetuned on a plurality of datasets.

20. The computer program product of claim 15, wherein one or more finetuned machine learning models of the plurality of finetuned machine learning models are previously finetuned on a plurality of finetuning methods.
